(19) United States
(12) Patent Application Publication
(10) Pub. No.: US 2015/0107633 A1
(43) Pub. Date: Apr. 23, 2015

(54) EXERCISE MAT CLEANING SYSTEMS AND DEVICES

(71) Applicants: Garrett Hartwell, Portland, OR (US); Paul Nguyen, Portland, OR (US); Terry L. Briscoe, Portland, OR (US); Karsten D. Zuendel, Portland, OR (US)

(72) Inventors: Garrett Hartwell, Portland, OR (US); Paul Nguyen, Portland, OR (US); Terry L. Briscoe, Portland, OR (US); Karsten D. Zuendel, Portland, OR (US)

(21) Appl. No.: 14/522,130

(22) Filed: Oct. 23, 2014

Related U.S. Application Data
(60) Provisional application No. 61/894,656, filed on Oct. 23, 2013.

(51) Int. Cl. B08B 1/02; B08B 1/04

(52) U.S. Cl. CPC B08B 1/02; B08B 1/04
USPC 134/122 R

(57) ABSTRACT

Exercise mat cleaning systems including a housing including an inlet for feeding the exercise mat into the housing, a debris removal subsystem for removing larger debris from the surfaces of the mat, a disinfection subsystem for removing smaller debris and contaminants from the surfaces of the mat, an outlet for feeding the exercise mat out of the housing are shown and described. In some examples, cleaning systems include an approved mat detection subsystem. In some further examples, cleaning systems include a drying subsystem for drying the surfaces of the mat. In even other examples, the cleaning systems can include a mat unrolling subsystem and/or a mat rolling subsystem.

### CROSS REFERENCE TO RELATED APPLICATIONS

This application claims the benefit under 35 U.S.C. §119(e) of U.S. Provisional Patent Application, Ser. No. 61/894,656, filed on Oct. 23, 2013, which is hereby incorporated by reference for all purposes.

### BACKGROUND

The present disclosure relates generally to cleaning systems and devices for exercise mats. In particular, cleaning systems that effectively remove debris and disinfect exercise mats fed through the cleaning systems are described.

Many sports activities, such as yoga and pilates, utilize exercise mats comprised of a flexible material. The mats provide a stable and soft foundation for performing athletic activities. Often times after an activity, the mats are left dirty with sweat and/or other debris. Occasionally athletic gyms, yoga studio employees, or individual mat users will spray their mats with a sanitizer spray and wipe the mats down with paper towels. This process is not only time intensive, but also does not sufficiently sanitize the mat. Especially if the mats are publicly used (i.e., not a personal mat), insufficient sanitization can lead to an undesirable condition of the mat, such as having a foul odor, and/or the spread of disease. Additionally, through this cleaning process, waste from the paper towels is being created.

Known mat cleaning systems are not entirely satisfactory for the range of applications in which they are employed. For example, U.S. Pat. No. 8,479,342 to Benson et al. (hereinafter referred to as “Benson”) provides an example including a cleaning device that utilizes a roller half submerged in a trough to apply solution to the mat as it passes by. The example cleaning system of Benson is unsatisfactory for a variety of reasons. In a first example, the cleaning solution is continually contaminated with each use of the device, leaving the solution dirty and even spreading the dirty solution onto mats subsequently run through the system. Additionally, no debris removing functions are provided, which in turn deposits debris, such as dust, dirt, hair, etc., into the cleaning solution reservoir.

In a second example, when the mat exits the device, it is left loose and unrolled. Thus, Benson requires that a user or gym employee roll the mat by hand in order to prepare the exercise mat for storage and/or transport. In even another example, the system of Benson has no method of tracking use and/or limiting use to specific mats. The present disclosure discusses examples of cleaning and sanitizing devices for mats that address the needs described above, including the aforementioned shortcomings of Benson.

Thus, there exists a need for exercise mat cleaning systems and devices that improve upon and advance the design of known exercise mat cleaning systems. Examples of new and useful exercise mat cleaning systems and devices relevant to the needs existing in the field are discussed below.

Disclosure addressing one or more of the identified existing needs is provided in the detailed description below. Examples of references relevant to exercise mat cleaning systems include U.S. Patent References: U.S. Pat. No. 3,333,291, U.S. Pat. No. 3,304,566, U.S. Pat. No. 3,396,422, U.S. Pat. No. 3,646,785, U.S. Pat. No. 4,104,755, U.S. Pat. No. 4,368,627, U.S. Pat. No. 5,013,367, U.S. Pat. No. 5,259,560, U.S. Pat. No. 5,511,471, U.S. Pat. No. 7,100,862, U.S. Pat. No. 7,353,670, U.S. Pat. No. 7,496,983, U.S. Pat. No. 8,286,292, patent publication 20120298787, and patent publication 20120325267. The complete disclosures of the above patents and patent applications are herein incorporated by reference for all purposes.

### SUMMARY

The present disclosure is directed to exercise mat cleaning systems each having a housing including an inlet for feeding the exercise mat into the housing, a debris removal subsystem for removing larger debris from the surfaces of the mat, a disinfection subsystem for removing smaller debris and contaminants from the surfaces of the mat, an outlet for feeding the exercise mat out of the housing. In some examples, cleaning systems include an approved mat detection subsystem. In some further examples, cleaning systems include a drying subsystem for drying the surfaces of the mat. In even other examples, the cleaning systems can include a mat unrolling subsystem and/or a mat rolling subsystem.

### BRIEF DESCRIPTION OF THE DRAWINGS

FIG. 1 is a perspective view of a first example of an exercise mat cleaning system.

FIG. 2 is a schematic diagram of the first example exercise mat cleaning system shown in FIG. 1.

FIG. 3 is a side elevation view of the first example exercise mat cleaning system shown in FIG. 1.

FIG. 4 is a front elevation view of the first example exercise mat cleaning system shown in FIG. 1.

FIG. 5 is a top plan view of the first example exercise mat cleaning system shown in FIG. 1.

FIG. 6 is a bottom plan view of the first example exercise mat cleaning system shown in FIG. 1.

FIG. 7 is a perspective view of a first example cleaning fluid dispensing device.

FIG. 8 is a perspective view of a first example of a continuous track roller mechanism.

FIG. 9 is a side elevation view of the first example exercise mat cleaning system of FIG. 1 including the first example continuous track roller mechanism shown in FIG. 8.

FIG. 10 is a front elevation view of the first example exercise mat cleaning system of FIG. 1 including the first example continuous track roller mechanism shown in FIG. 8.

FIG. 11 is a perspective view of a first example of a mat guide mechanism.

FIG. 12 is a side elevation view of the first example exercise mat cleaning system of FIG. 1 including the first example mat guide mechanism shown in FIG. 11.

FIG. 13 is a schematic diagram of a second example of an exercise mat cleaning system.

FIG. 14 is a side elevation view of the second example exercise mat cleaning system schematically depicted in FIG. 13.

FIG. 15 is a top plan view of the second example exercise mat cleaning system schematically depicted in FIG. 13.

FIG. 16 is a perspective view of a first example of a mat roll chamber.

### DETAILED DESCRIPTION

The disclosed exercise mat cleaning systems and devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various mat cleaning systems and devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

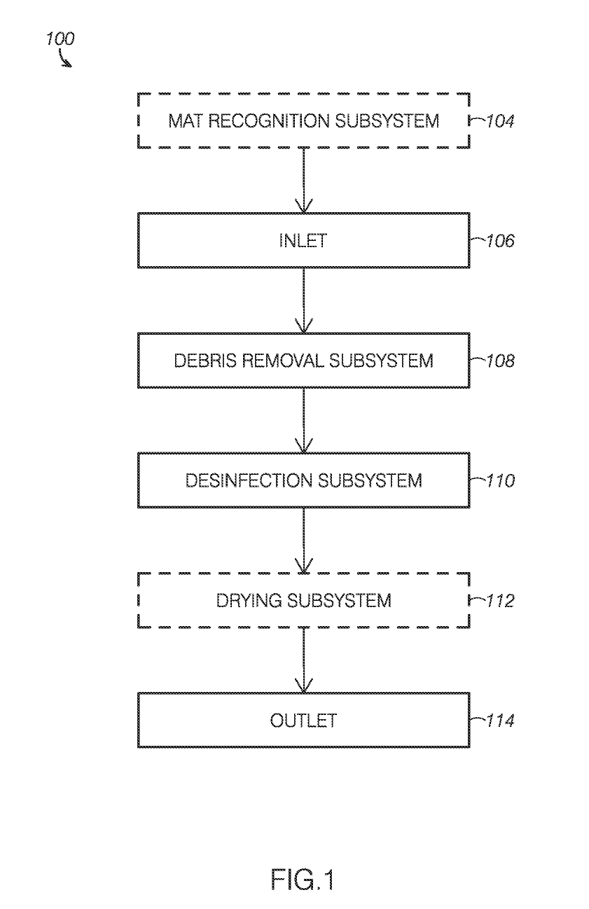

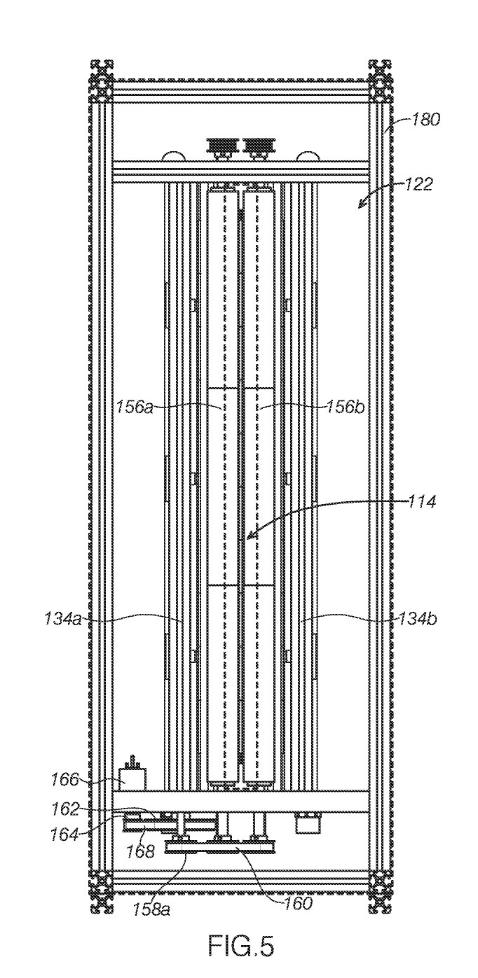

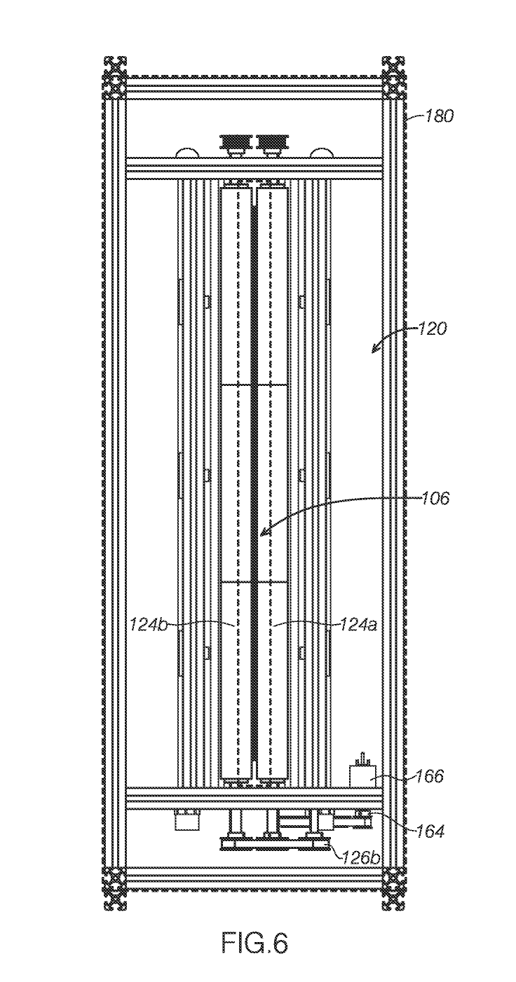

With reference to FIGS. 1-12, a first example of an exercise mat cleaning system, cleaning system 100, will now be described. Exercise mat cleaning system 100 is a vertically aligned system that includes an inlet 106, a debris removal subsystem 108, a disinfection subsystem 110, and an outlet 114. Cleaning system 100 can optionally include a mat recognition subsystem 104 upstream of inlet 104. Further, cleaning system 100 can include a drying subsystem downstream of disinfection system 110 and upstream of outlet 114.

Cleaning system 100 functions to effectively remove debris and disinfect a soiled exercise mat by feeding the mat through the system and cleaning the mat with unused (i.e., fresh) cleaning solution. Additionally or alternatively, exercise mat cleaning system 100 can be used to permit and/or track approved mats through the system. Also, additionally or alternatively, exercise mat cleaning system 100 can be used to dry cleaned exercise mats.

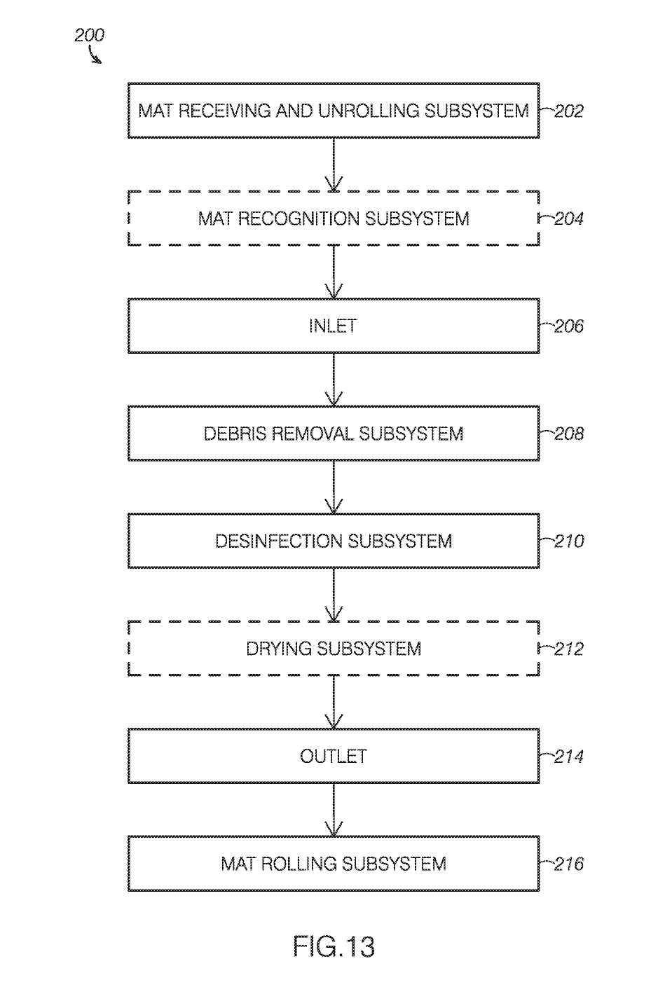

With reference to FIGS. 13-16, a second example of an exercise mat cleaning system, cleaning system 200, will now be described. Exercise mat cleaning system 200 is a horizontally aligned system that includes a mat unrolling subsystem 202, an inlet 206, a debris removal subsystem 208, a disinfection subsystem 210, an outlet 214, and a mat rolling subsystem 216. Cleaning system 200 can optionally include a mat recognition subsystem 204 upstream of inlet 206 and downstream of mat unrolling subsystem 202. Further, cleaning system 200 can include a drying subsystem 212 downstream of disinfection system 210 and upstream of outlet 214.

Cleaning system 200 functions to effectively remove debris and disinfect a soiled exercise mat by feeding the mat through the system and cleaning the mat with unused (i.e., fresh) cleaning solution. Further, cleaning system 200 can receive the mat in a rolled configuration and substantially unroll the mat as it is fed into the system. Furthermore, as the mat is fed out of the outlet, cleaning system 200 rolls the mat into a rolled configuration. Additionally or alternatively, exercise mat cleaning system 200 can be used to permit and/or track approved mats through the system. Also, additionally or alternatively, exercise mat cleaning system 200 can be used to dry cleaned exercise mats.

As can be seen in the schematic view of FIG. 1 and described above, cleaning system 100 includes inlet 106 for feeding an exercise mat into debris removal system 108. Disinfection subsystem 110 is downstream of debris removal subsystem 108 so that larger debris is removed prior to cleaning and disinfection of the mat. Outlet 114 is downstream of disinfection subsystem 110 for feeding the mat out of the cleaning system.

Cleaning system 100 can optionally include mat recognition subsystem 104 (i.e., an approved mat recognition subsystem) upstream of inlet 106 for identifying an approved exercise mat and operating the cleaning system in response to identification of the approved mat. Additionally or alternatively, mat recognition subsystem 104 can be used to track user identification information and/or use information for the cleaning system. Inclusion of the mat recognition subsystem in the cleaning system has the advantage that exercise mats that are made of material and/or have dimensions that are not compatible with the cleaning system will not be initiate operation of the cleaning system. Introduction of exercise mat with non-compatible materials and/or dimensions can jam and/or break the cleaning system. Only specific mats, made of approved materials with specific dimensions can safely enter the machine. Additionally, the recognition subsystem limits introduction of foreign objects from entering and/or operating the cleaning system.

Further, cleaning system 100 can optionally include a drying subsystem 112 upstream of outlet 114 and downstream of disinfection subsystem 110. Drying subsystem 112 can be used to dry excess cleaning solution from a mat prior to feeding the mat out of the cleaning system.

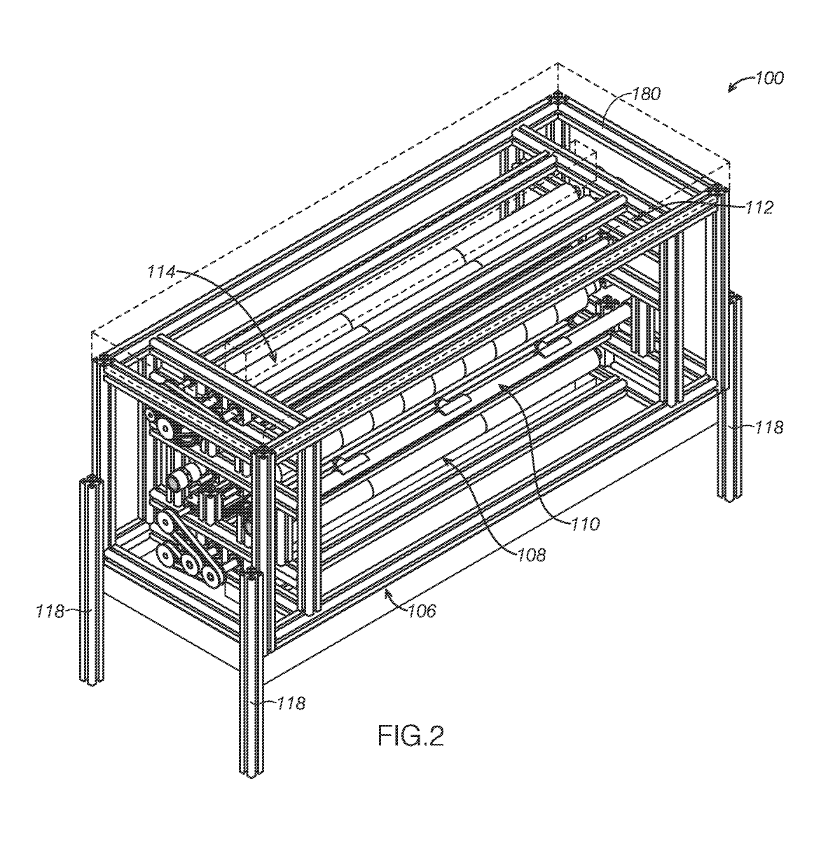

A perspective view of one specific example of cleaning system 100 is shown in FIG. 2. In this example, cleaning system 100 includes a housing 180 for housing, supporting, and/or containing the components of cleaning system 100 (e.g., mat identification subsystem 104, inlet 106, debris removal subsystem 108, disinfection subsystem 110, drying system 112, and outlet 114). Housing 180 is supported by legs 118. As depicted in FIGS. 2-6, cleaning system 100 is a vertically aligned system with inlet 106 being on a bottom side 120 of housing 180 and outlet 114 being on a top side 122 of housing 180. This orientation is advantageous because as debris and/or used cleaning solution is drawn downwards by gravity as the mat moves upward through the cleaning system. Thus, debris and/or used cleaning solution are drawn away from a clean portion of the exercise mat.

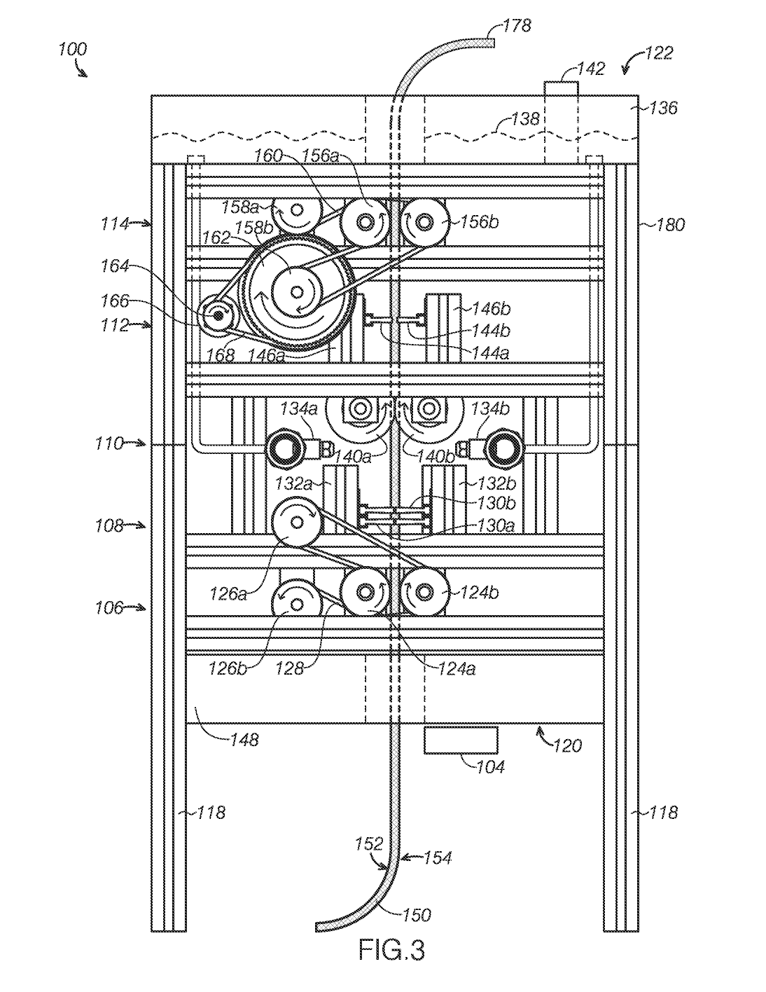

As shown in FIG. 3, mat recognition subsystem 104 is disposed proximal to inlet 106 and upstream of inlet 106. Mat recognition subsystem 104 is configured to detect a tag 178 in mat 150. In the present example, tag 178 is located in a lateral edge of mat 150. It will be appreciated that in alternate examples, the tag can be in any desired location of the mat that is integral to the mat and/or on a surface of the mat (e.g., embedded in a center of the mat, on a longitudinal edge of the mat, etc.). In response to recognition of an approved tag (i.e., tag 178), mat recognition subsystem 104 is configured to operate cleaning system 100 for cleaning and disinfection of the approved mat.

In one example, mat recognition subsystem 104 can be an RFID recognition system configured to recognize an acceptable RFID tag on the mat. In another example, mat recognition subsystem 104 can be an optical system configured to recognize an acceptable optical tag (e.g., a cut out, a marking, a clip, etc.) on the mat. In even another example, mat recognition subsystem 104 can be a magnetic recognition system configured to recognize an acceptable magnetic tag on the mat. It will be appreciated that the mat recognition subsystem can include any mechanism for acceptable mat recognition that is known or yet to be discovered.

Returning to FIG. 3, inlet 106 includes a pair of rollers 124 (124a and 124b) that are rotatable in opposing directions to contact opposing surfaces of an exercise mat 150 and feed the mat into the system. Arrows indicate opposing directions for rotation for rollers 124. Specifically, roller 124a contacts a first side 152 of mat 150 and is rotatable in a counterclockwise direction, while roller 124b contacts a second side 154 of mat 150 and is rotatable in a clockwise direction.

Rollers 124 are comprised of a firm and/or frictional material (e.g., hard rubber, hard plastics, durable fabric, any material which can provide non-corrosive properties, etc.). The rollers are preferably made of a plastic or rubber material that is tacky and grips the mat, providing a high degree of static friction, allowing the rollers to move the mat through the cleaning system; however, other materials may be used depending on the intended use and application. For example, in a case where the rollers are comprised of durable fabric, the internal core of the rollers may be comprised of a different material that provides a more rigid skeletal structure.

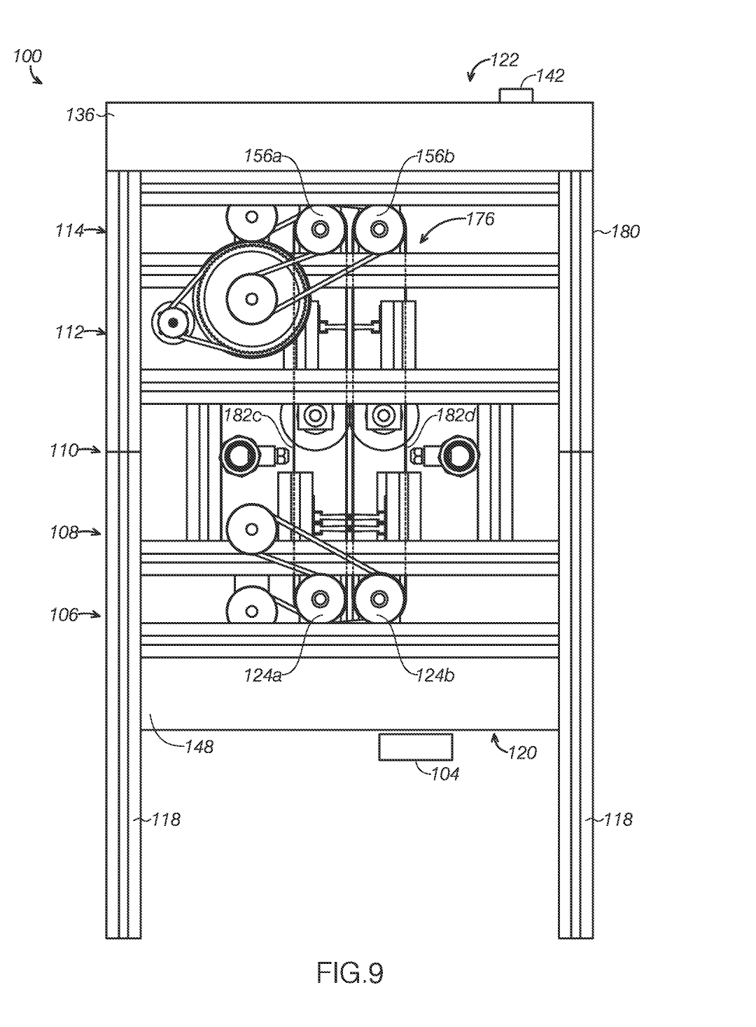

In the present example, rollers 124 and pulleys 126 (126a and 126b) are operably connected to a belt 128 for driving rotation of rollers 124. Belt 128 is operably connected to a drive shaft of a motor (e.g., driveshaft 164 and motor 166, a separate drive shaft and motor, etc.). In the present example, one of pulleys 126 is indirectly coupled to the motor via an additional belt (not specifically shown). Specifically, the rollers 126 and 156 are connected by a belt attached to the pulleys on the opposite side of the drive components described in FIG. 9. The pulley from 156b would connect to the pulley on 124b on the opposite side shown in FIG. 9.

Further, pulley 126a is operable in a clockwise direction and pulley 126b is operable in a counterclockwise direction. In alternate examples, the inlet can include more or fewer pulleys for driving rotation of the inlet rollers. In other alternate examples, one or more of the inlet rollers can be directly or indirectly coupled a motor to drive rotation of the inlet rollers.

Also shown in FIG. 3, debris removal subsystem 108 includes a pair of wipers 130 (130a and 130b). Wiper 130a is attached to a support wall 132a and wiper 130b is attached to a support wall 132b. Support walls 132 are affixed to housing 180.

As an exercise mat is fed through the cleaning system, wiper 130a removes debris from first side 152 of mat 150 and wiper 130b removes debris from second side 154 of mat 150. The wipers are situated in a fashion so that the mat can pass through while both wipers come in contact with the mat, applying light pressure. This light pressure does not inhibit the mat from passing through the cleaning device; however, the light pressure is strong enough to remove excess debris and/or sweat moisture.

Wipers 130 are comprised of a semi-flexible material (e.g., rubber, silicone, etc.). As debris is removed from the mat, it falls downward due to the force of gravity on the debris. In alternate examples, the debris removal subsystem can include one or more brushes instead of one or more of the wipers. In even other alternate examples, the debris removal subsystem can include a vacuum mechanism, an air curtain (i.e., air knife), and/or another agitation mechanism. Debris from the mat can be collected in a collection basin 148 attached to and/or disposed proximally to bottom side 120 of housing 180.

As described above, collection basin 148 is disposed below other components in cleaning subsystem 100. Accordingly, collection basin 148 is configured to collect debris, solution, and/or moisture run-off. Collection basin 148 can be disposed with an angled floor in order to funnel the contents to one corner of the collection basin. At this corner can be one or more fluid interfaces, which may define orifices that allow the collection basin to transfer fluid to the exterior of system, such as by draining the fluid. One fluid interface can be designed to allow the user to plumb a connection to the cleaning system, allowing for the contents to be drained and fed into an existing sanitary water system. The second fluid interface can be designed with a valve that allows the user to periodically drain the contents (by use of gravity) into a bucket or other collection device for disposal. An inline condensate pump could be added to the collection basin to assist in emptying its contents. Further, a flushing mechanism can be included to receive fresh water and flush out debris and used cleaning solution from the collection basin.

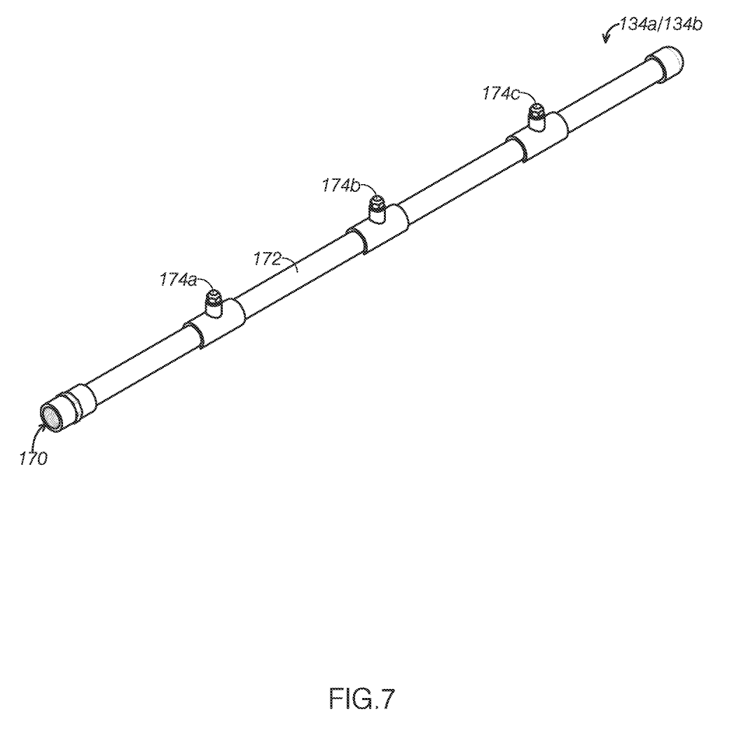

Returning to FIG. 3, disinfection subsystem 110 includes a pair of spray assemblies 134 (134a and 134b) that are fluidly coupled to a cleaning solution reservoir 136. Reservoir 136 is configured to retain cleaning solution 138. Spray assembly 134a is configured to spray fresh and unused cleaning solution onto first side 152 of mat 150, while spray assembly 134b is configured to spray fresh and unused cleaning solution onto second side 154 of mat 150. As depicted in FIG. 7, each of spray assemblies 134 includes an open end inlet 170, an elongate tubular body 172, and three spray dispensers 174 (174a, 174b, and 174c). In alternate examples, the spray assembly inlet can have a different configuration and/or the assembly can include more or fewer spray dispensers. It will be appreciated that the spray assembly can have any configuration for a spray assembly that is known or yet to be discovered.

Reservoir 136 is located at a top of the housing 180 and is filled with sanitizing solution. The solution reservoir is positioned at the top of the housing with a port 142 extending through the housing and/or the reservoir that allows users to easily fill the solution reservoir with sanitizing solution when necessary. The solution reservoir can also include an electronic liquid level float switch (not specifically shown) that indicates low solution level once the solution falls below a set point. This display may be located on the exterior of the housing, such as a low solution light or other visible mechanism (e.g., display on a GUI).

In the present example, disinfection subsystem 110 further includes a pair of rollers 140 (140a and 140b) that include a textured surface (e.g., a surface including grooves, sponge, steel wool, spines, brush, etc.) and are operable in opposing directions. Arrows indicate opposing directions for rotation for rollers 140. Roller 140a is configured to contact first side 152 of mat 150 and is rotatable in a counterclockwise direction, while roller 140b is configured to contact second side 154 of mat 150 and is rotatable in a clockwise direction. Accordingly, rollers 140 agitate the surfaces of the exercise mat after cleaning solution has been dispensed on the mat surfaces in order to disinfect the surfaces of the mat.

In one example, rotation of rollers 140 is driven by movement of the mat through the cleaning system. In another example, rollers 140 can be coupled to a motor (e.g., directly coupled to a motor, indirectly coupled via a belt drive mechanism, etc.). In this example, rollers 140 can be operated the same speed or a different speed than inlet rollers 124. In one specific example, rollers 140 are operated at a faster speed than rollers 124 so that rollers 140 are rotated over the surfaces of the mat faster than the movement of the mat through the cleaning system. Accordingly, the faster moving rollers can provide a greater degree of agitation to the surfaces of the mat. Additionally or alternatively, rollers 140 can be operated in an opposing direction (i.e., roller 140a operated in a clockwise direction and roller 140b operated in a counterclockwise direction) to provide a greater degree of agitation to the surfaces of the mat.

In alternate examples, the disinfection subsystem can include mesh rollers that are directly coupled to the cleaning solution reservoir. In these alternate examples, the rollers are a mechanism for dispensing fresh cleaning solution onto the surfaces of the mat. Accordingly, these examples can exclude the spray assemblies. The mesh rollers can be arranged together or separately. In a separated orientation, the mesh rollers sanitize only one side of the mat at a time. In this separated layout, the mesh rollers can be paired with a wiper or a guide bar. Where each mesh roller is paired with a wiper, a collection channel can sit below the wiper, spanning the length of the wiper with some additional overlap.

Again returning to FIG. 3, in the present example, cleaning system 100 includes drying subsystem 112. Once the mat passes through the disinfection subsystem, it is passed through a second pair of wipers 144 (144a and 144b). Wiper 144a is attached to a support wall 146a and wiper 144b is attached to a support wall 146b. As an exercise mat is fed through the cleaning system, wiper 144a removes excess cleaning solution from first side 152 of mat 150 and wiper 144b removes excess cleaning solution from second side 154 of mat 150. The wipers are situated in a fashion so that the mat can pass through while both wipers come in contact with the mat, applying light pressure. This light pressure does not inhibit the mat from passing through the cleaning device; however, the light pressure removes excess cleaning solution.

In some examples, one or more collection channels can be disposed beneath wipers 144 that are configured to collect the excess cleaning solution removed by the wipers. The collection channels can be angled so that the excess cleaning solution collects and runs off to one side. When the solution reaches the run off side of the collection channel it can run down an enclosed side wall section of the housing and can be collected at the bottom of the cleaning system in collection basin 148.

Similar to wipers 130, wipers 144 are comprised of a semi-flexible material (e.g., rubber, silicone, etc.). As excess cleaning solution is removed from the mat, it falls downward due to the force of gravity on the cleaning solution. Additionally or alternatively, drying subsystem 112 can include additional or supplemental components. In one specific example, drying subsystem 112 additionally includes UV lights downstream of wipers 144. In this example, after the mat has been dried on both sides by the wipers, it passes between the pair of UV lights. The UV lights can provide both additional drying and sanitizing functions. The drying function comes from the heat of the bulb, which can evaporate remaining cleaning solution. The sanitizing function of the UV lights is provided by the properties of the ultra-violet light rays, which can kill remaining bacteria.

In other specific examples, the drying subsystem can additionally or alternatively include rollers having a surface comprised of an absorbent material and/or compression rollers. In this example, the mat is fed in between the absorbent rollers and/or the compression rollers to dry the surfaces of the mat. Specifically, in an example including compression rollers, the mat is tightly pressed against the surface of an opposing roller to prevent excess cleaning solution from passing through the compression rollers. In even another alternate example, the drying subsystem can additionally or alternatively include a vacuum and/or air blades for drying the surfaces of the mat. In examples including or excluding a drying subsystem, the cleaning solution can include alcohol to assist in drying via evaporation of the cleaning solution from the surfaces of the mat.

As depicted in FIG. 3, cleaning system 100 further includes outlet 114 downstream of drying subsystem 112. In the present example, outlet 114 includes a pair of rollers 156 (156a and 156b) that are rotatable in opposing directions to contact opposing surfaces of an exercise mat 150 and feed the mat out of the cleaning system. Arrows indicate opposing directions for rotation for rollers 156. Specifically, roller 156a contacts a first side 152 of mat 150 and is rotatable in a counterclockwise direction, while roller 156b contacts a second side 154 of mat 150 and is rotatable in a clockwise direction.

Rollers 156 are comprised a firm and/or frictional material (e.g., hard rubber, hard plastic, durable fabric, any material which can provide non-corrosive properties, etc.). The rollers are preferably made of a plastic or rubber material that is tacky and grips the mat, providing a high degree of static friction, allowing the rollers to move the mat through the cleaning system; however, other materials may be used depending on the intended use and application. For example, the internal core of the rollers may be comprised of a different material that provides a more rigid skeletal structure.

In the present example, rollers 156 and pulleys 158 (158a and 158b) are operably connected to a belt 160 for driving rotation of rollers 156. As shown in FIG. 3, pulley 158b is operatively connected to a fly wheel 162, which is connected to a drive shaft 164 of a motor 166. Motor 166 can be a small and compact servomotor. In one specific example, motor 166 has dimensions of 2″×4″×2″.

In the present example, drive shaft 164 is operatively connected to fly wheel 162 via a belt 168. Drive shaft 164 and roller 156b are operable in a clockwise direction and flywheel 162, pulleys 158, and roller 156a are operable in a counter clockwise direction. In alternate examples, the outlet can include more or fewer pulleys and/or belts for driving rotation of the outlet rollers. In other alternate examples, one or more of the outlet rollers can be directly or indirectly coupled the motor to drive rotation of the outlet rollers.

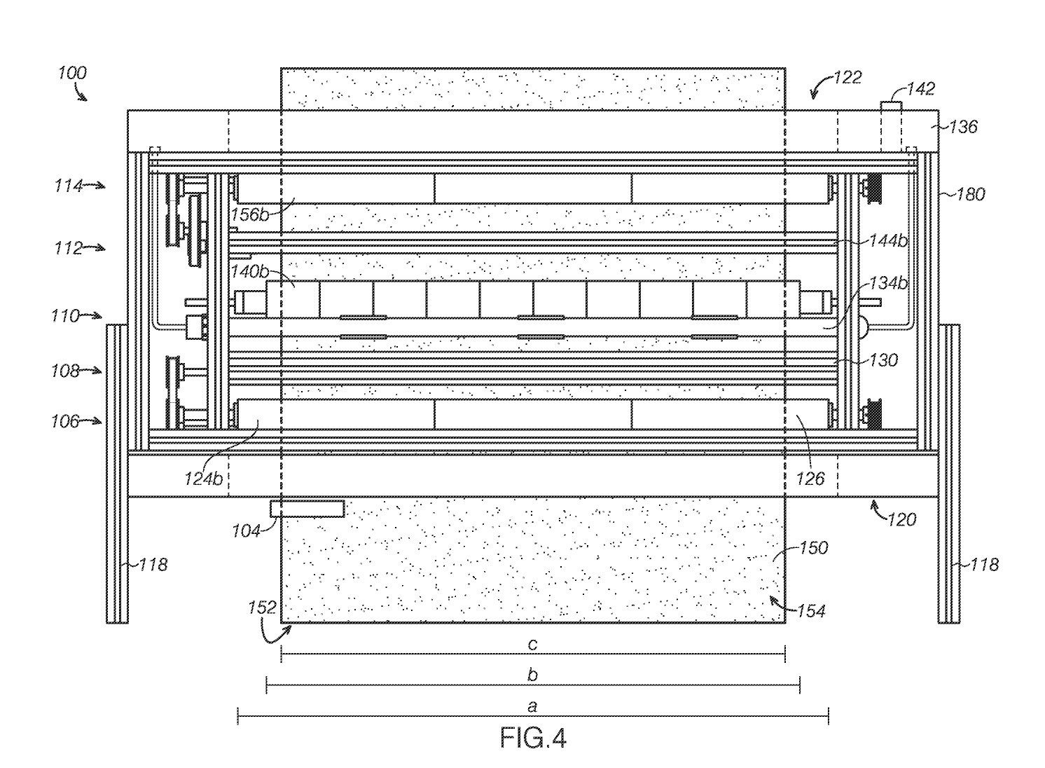

In each of the above described components of cleaning system 100, the length of the rollers and wipers is greater than the width of the mat so as to provide sufficient debris removal. As shown in FIG. 4, rollers 124, rollers 156, wipers 144, wipers 130, and spray assemblies 134 have a width a, while rollers 140 have a width b. Mat 150 has a width c. In this example, the length a is greater than the length b, and the length b is greater than the length c. In other examples, rollers 140 can have an equal or greater length relative to rollers 124 and 156.

In one specific example, now referring to the dimensional characteristics simply as a means to describe relative size of the internal components depicted in FIGS. 2-6, the inlet and outlet rollers can be from 0.75″ to 2″ in diameter depending on desired size and durability. Some applications, where use is frequent, may require a more robust design with larger components. Larger diameter inlet and outlet rollers and at a higher rate of speed without damaging the mat, yet still provide sufficient cleaning of the mat. For most applications (e.g., in average size studios and for home use), inlet and outlet rollers may be smaller in diameter, on the order of 0.25″ to 1″ and run the width of the mat (e.g., 24″) with additional room at the ends. The disinfection subsystem rollers are of a greater diameter, approximately 2″, and share a comparable length as the above members at approximately 24.5″, again spanning the width of the mat.

The wipers also have a length of approximately 25″, spanning the length of the mat with additional margins at each side of the mat. The wipers have approximately ¾″ depth with a solid square base and a long narrow flexible head that comes to a finishing point or leading edge configured to contact the mat. An area below each wiper can include a collection channel with outside dimensions of approximately 3″×27″×3″. The internal channel of the collection channel can resemble the form of a trapezoid of varied depth starting at 1″ and growing to 2.5″, with bases of 1½″ and 2½″.

The cleaning solution reservoir is disposed proximal to the top side of the system and can have dimensions of approximately 4″×25″×6″, thereby providing approximately 10 liters or 2.5 gallons of storable cleaning solution space. Depending on the specific model of the cleaning device and the intended use, for example a small yoga studio or home use vs. a large yoga studio, the volume of the solution reservoir may be varied. The collection basin is disposed proximal to a bottom side of the system and can have dimensions that allow the collection basin to have a comparable or greater volume capacity relative to the cleaning solution reservoir.

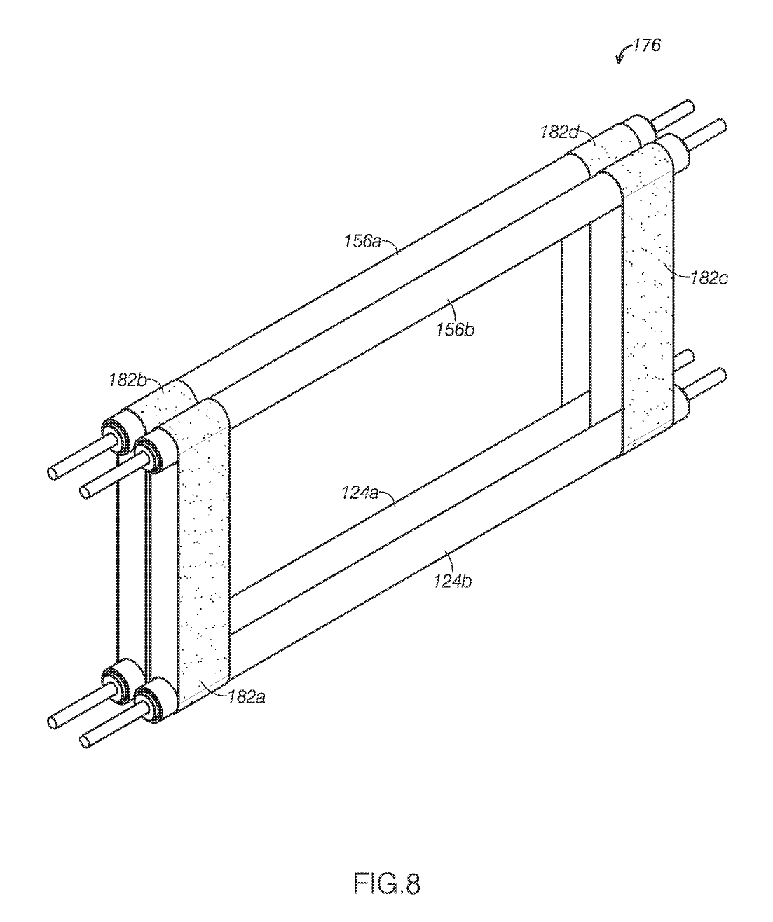

FIGS. 8-10 depict an example continuous track mechanism, continuous track mechanism 176, which can be used in combination with cleaning system 100. As depicted in FIG. 8, continuous track mechanism 176 includes inlet rollers 124, outlet roller 156, and tracks 182 (182a-182d). Tracks 182 are configured to continuously contact opposing longitudinal edges of a mat going through the cleaning system in order to move the mat through the cleaning system. The tracks can be comprised of a plastic or rubber material that is tacky and grips the mat, providing a high degree of static friction. Thus, the continuous track mechanism has the advantage that it can continuously contact the mat and provide a greater degree of traction (i.e., continuous traction) to move the mat through the cleaning system. It will be appreciated that the continuous track mechanism can be used with the inlet and outlet rollers or be mounted on a separate set of rollers.

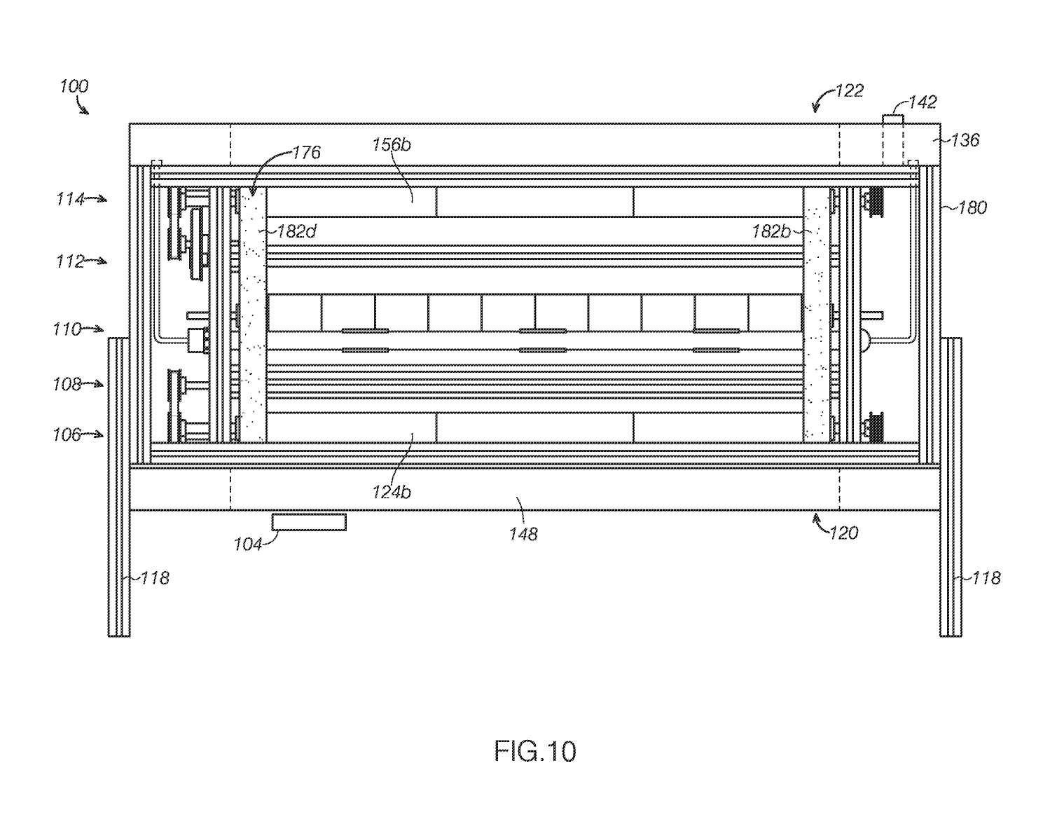

FIGS. 9 and 10 show roller track mechanism 176 used in combination with cleaning system 100. Continuous track mechanism 176 is extends between bottom 120 and top 122 of housing 180. In the present example, the continuous track mechanism is powered by motor 166 via the above described pulley and belt systems. Alternatively, if the continuous track mechanism includes a separate set of roller, the continuous track mechanism can be powered by a separate motor.

In other alternate examples, the cleaning system can include more than one continuous track mechanism. In other words, the cleaning system can include multiple continuous track mechanisms having a lesser height than the depicted example of FIGS. 9 and 10. In one specific example, the cleaning system includes a first continuous track mechanism between the inlet and the debris removal subsystem, a second continuous track mechanism between the disinfection subsystem and the drying subsystem, and a third continuous track mechanism between the drying subsystem and the outlet. In these alternate examples, the continuous track mechanism may include wider tracks that extend across the width of the mat rather than contacting only longitudinal edges of the mat.

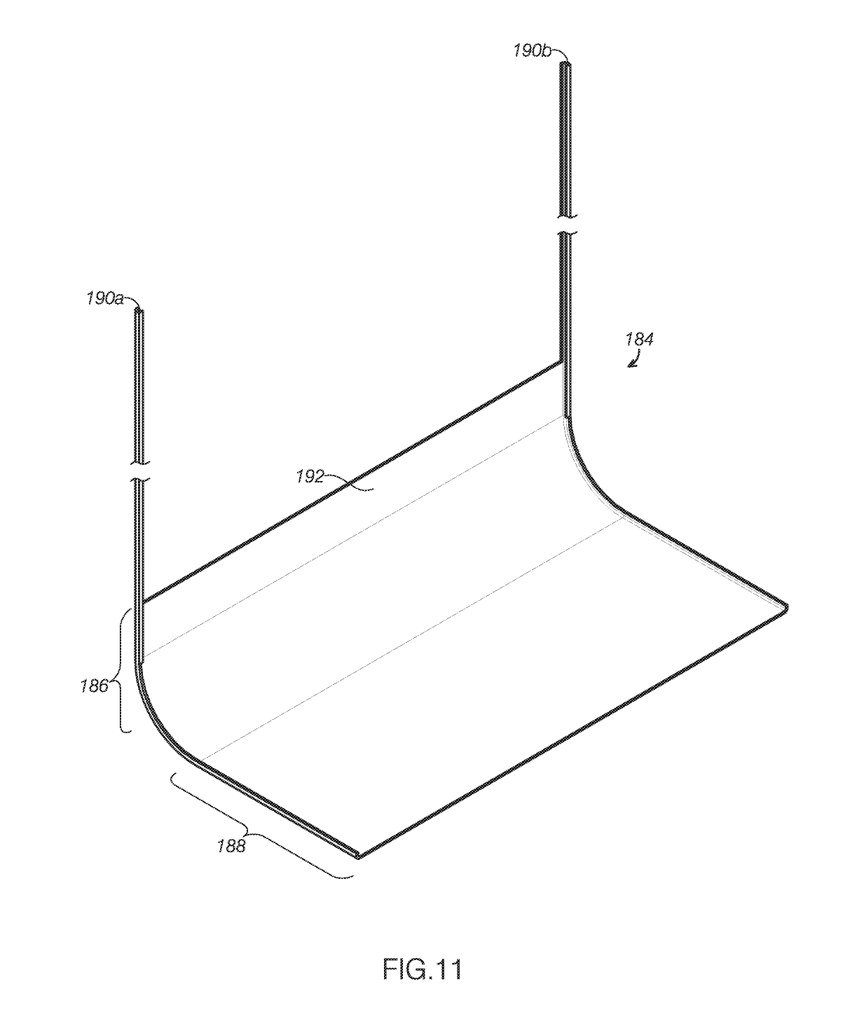

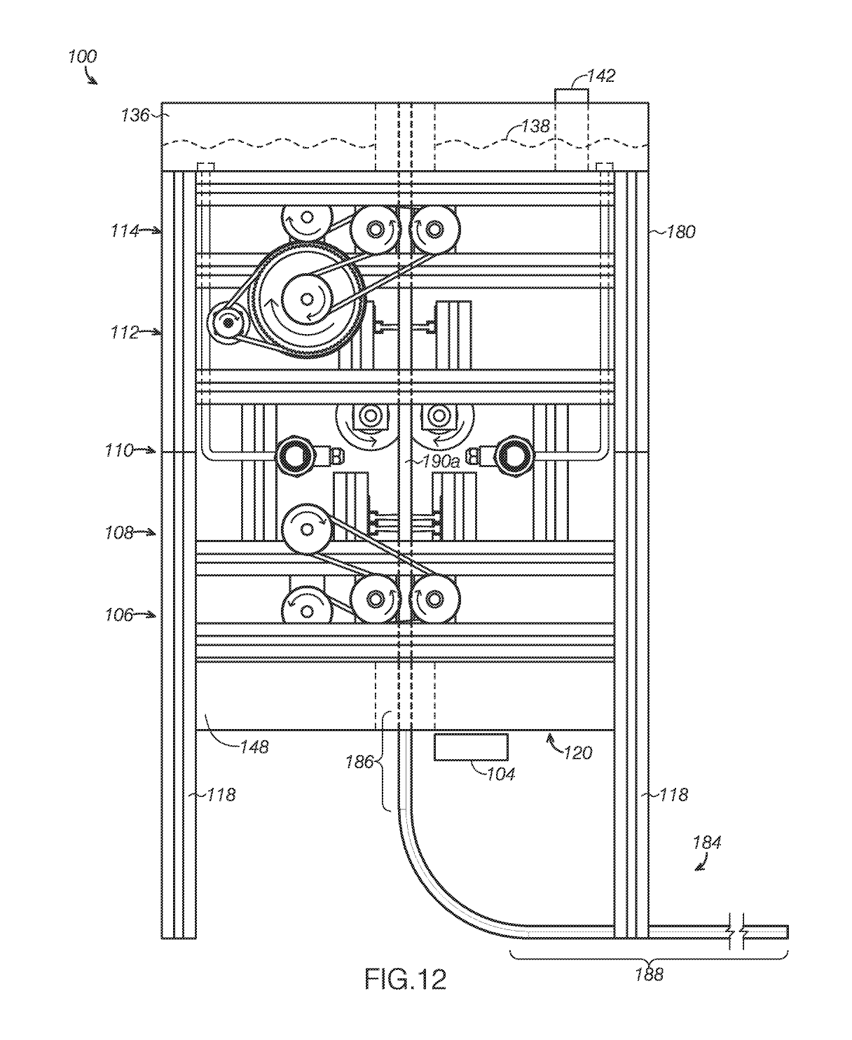

FIGS. 11 and 12 depict an example mat guide mechanism, mat guide 184, which can be used in combination with cleaning system 100. As shown in FIG. 11, mat guide 184 can include a vertical wall 186 and a horizontal wall 188 with a curvature joining the walls. Further, as depicted in FIGS. 11 and 12, mat guide 184 includes a planar sheet 192 with C-shaped grooves 190 (190a and 190b) on opposing edges of planar sheet 192. The C-shaped grooves are configured to contact and/or guide longitudinal edges of the mat as the mat moves through the cleaning system. It will be appreciated that the mat guide can have any desired shape and/or contour to support longitudinal edges of the mat.

Mat guides can be included in locations that may assist in preventing the mat from folding, rolling, and/or otherwise becoming misaligned as it moves through the cleaning system. As shown in FIG. 12, in one specific example, mat guide 184 is be associated with inlet 106 upstream of the inlet for guiding the mat into the cleaning system. Further, in the example of FIG. 12, C-shaped grooves 190a and 190b (only 190a is shown) extend upwards from inlet 106 to outlet 114. In other words, the mat guide mechanism aligns opposing longitudinal edges of the exercise mat as it moves through the inlet, the debris removal subsystem, the disinfection subsystem, and the outlet.

It will be appreciated that the example of FIG. 12 is just one example configuration for the mat guide mechanism and in other examples the cleaning system can include mat guides in any desired location for preventing the mat from folding, rolling, and/or otherwise becoming misaligned as it move through the cleaning system. Further, in some examples, the mat guides can include the planar sheet through the entire pathway of the mat through the cleaning system. In this example, only one side of the mat is cleaned at a time and cleaning system components on the second side of the mat can be excluded.

Turning attention to FIGS. 13-16, a second example of an exercise mat cleaning system, cleaning system 200, will now be described. Cleaning system 200 includes many similar or identical features to cleaning system 100. Thus, for the sake of brevity, each feature of cleaning system 200 will not be redundantly explained. Rather, key distinctions between cleaning system 200 and cleaning system 100 will be described in detail and the reader should reference the discussion above for features substantially similar between the two cleaning systems.

As can be seen in the schematic view of FIG. 13 and described above, cleaning system 200 includes exercise mat receiving and unrolling subsystem 202 upstream of inlet 206, which feeds an exercise mat into debris removal system 208. Disinfection subsystem 210 is downstream of debris removal subsystem 208 so that larger debris is removed prior to cleaning and disinfection of the mat. Outlet 214 is downstream of the disinfection subsystem for feeding the mat out of the cleaning system and mat rolling subsystem 216 is coupled to the outlet to roll the mat as it is fed out of the cleaning system.

Cleaning system 200 can optionally include mat recognition system 204 upstream of inlet 206 and downstream of mat unrolling subsystem 202 for identifying an approved exercise mat and operating the cleaning system in response to identification of the approved mat. Additionally or alternatively, mat recognition system 204 can be used to track user identification information and/or use information for the cleaning system. Further, cleaning system 200 can optionally include a drying subsystem 212 upstream of outlet 214 and downstream of disinfection subsystem 210. Drying subsystem 212 can be used to dry excess cleaning solution from a mat that has been cleaned prior to feeding the mat out of the cleaning system.

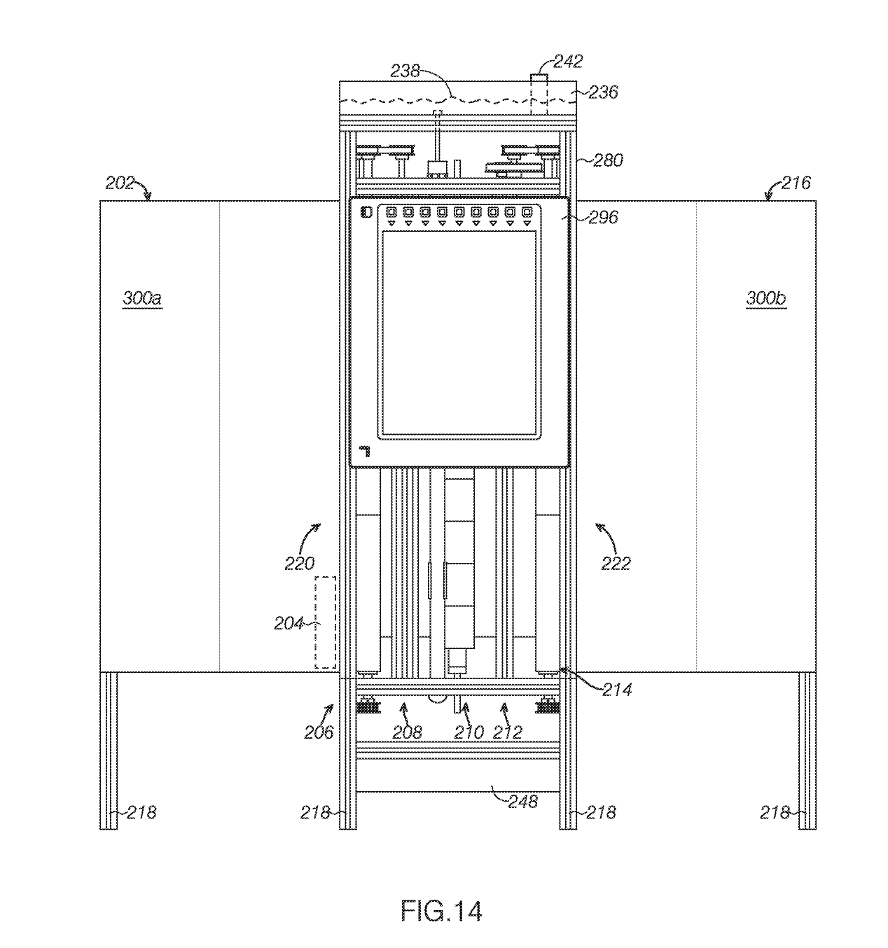

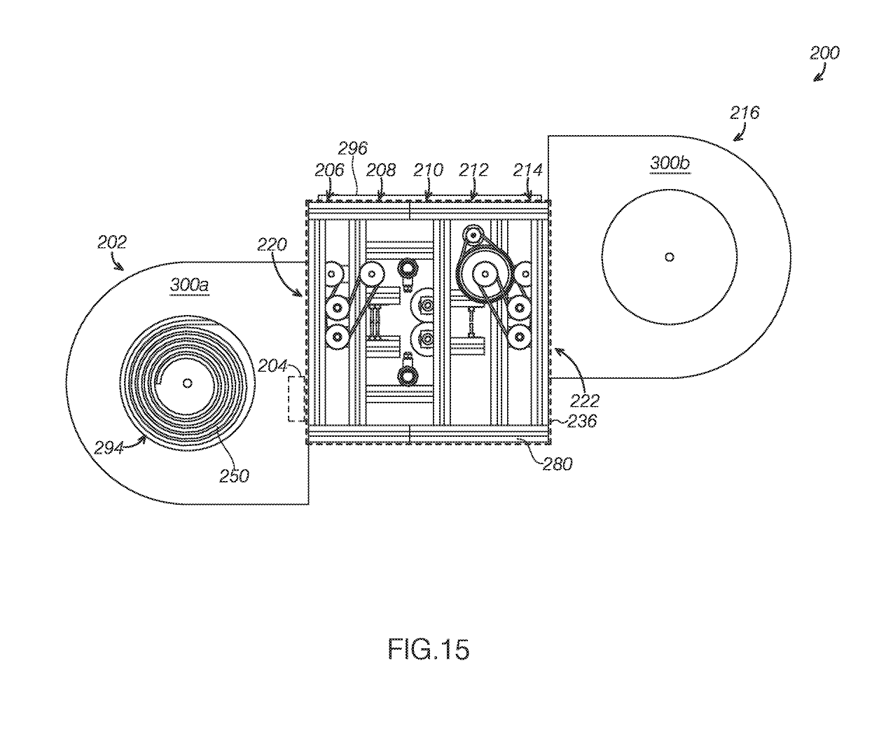

A front elevation view and a top plan view of one specific example of cleaning system 200 are shown in FIGS. 14 and 15, respectively. In this example, cleaning system 200 includes a housing 280 for housing, containing, and/or otherwise supporting the components of cleaning system 200 (e.g., mat unrolling subsystem 202, mat identification subsystem 204, inlet 206, debris removal subsystem 208, disinfection subsystem 210, drying subsystem 212, outlet 214, and mat rolling subsystem 216). Housing 280 is supported by legs 218.

As depicted in FIGS. 14 and 15, cleaning system 200 is a horizontally aligned system with inlet 206 being on a first side 220 of housing 280 and outlet 214 being on a second opposing side 222 of housing 280. This orientation is advantageous because the mat can be loaded in a rolled position, automatically unrolled to insert the mat into the cleaning system, and re-rolled as the mat exits the cleaning system. Further, debris and/or used cleaning solution are drawn downward by gravity as the mat moves through the cleaning system laterally and are collected in an underlying catch basin 248. In alternate examples, cleaning system 200 can be vertically aligned similar to cleaning system 100, and include the mat unrolling and/or mat rolling subsystems in a vertical orientation and include a catch basin having a configuration similar to that of catch basin 148. Further, in alternate examples for cleaning system 100, the system can be horizontally aligned and include a catch basin having a configuration similar to that of catch basin 248.

It will be appreciated that components of cleaning system 200 (i.e., mat identification subsystem 204, inlet 206, debris removal subsystem 208, disinfection subsystem 210, drying system 212, and outlet 214) are substantially similar to components of cleaning system 100 (i.e., mat identification subsystem 104, inlet 106, debris removal subsystem 108, disinfection subsystem 110, drying system 112, and outlet 114, respectively). Accordingly, the reader can reference the above descriptions of mat identification subsystem 104, inlet 106, debris removal subsystem 108, disinfection subsystem 110, drying system 112, and outlet 114 to understand the respective configurations of mat identification subsystem 204, inlet 206, debris removal subsystem 208, disinfection subsystem 210, drying system 212, and outlet 214. It will be further appreciated that cleaning system 200 can include continuous track mechanism 176 (shown in FIGS. 8-10) and/or mat guide mechanism 184 (shown in FIGS. 11 and 12).

In contrast to cleaning system 100, cleaning system 200 includes the mat unrolling subsystem 202 and mat rolling subsystem 216. In the example shown in FIGS. 14 and 15, mat unrolling subsystem 202 is coupled to inlet 206 includes a first mat roll chamber 300 (300a) and mat rolling subsystem 216 is coupled to outlet 214 and includes a second mat roll chamber 300 (300b). Mat unrolling subsystem 202 is configured to receive exercise mat 250 in a rolled configuration 294.

Exercise mats are often transported and/or stored in a rolled configuration. For example, a user will likely roll their mat to carry it to the cleaning system. Thus, cleaning system 200 has the advantage that the mat can be received in a rolled configuration and does not require unrolling of the mat by the user. Further, the cleaning system will automatically roll the mat as it exits the system and does not require the user to re-roll the mat by hand. It will be appreciated that in alternate examples the cleaning system can include one of the mat unrolling subsystem and the mat rolling subsystem.

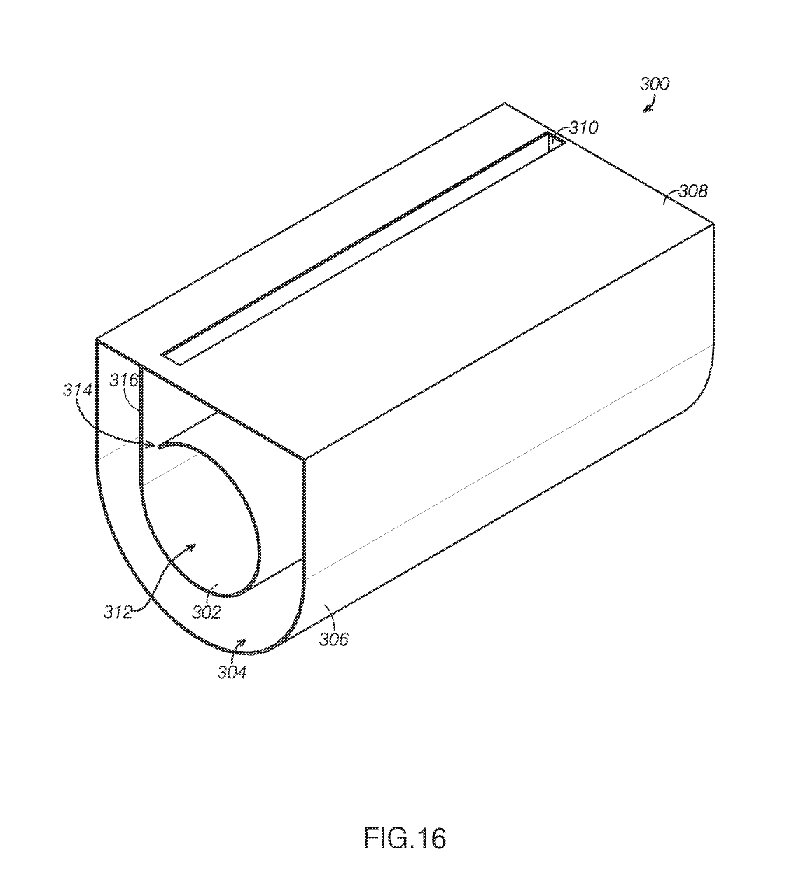

FIG. 16 shows a detailed view of one of the mat roll chambers 300. As depicted in FIG. 16, mat roll chamber 300 includes a mat sleeve 302 surrounded by an outer space 304 defined by an outer curved wall 306. Mat roll chamber 300 further includes a flat face wall 308, which is attached to outer curved wall 306. Flat face wall 308 is configured to be abutted to housing 280 and includes slotted opening 310 that is configured to be aligned with inlet 206 and/or outlet 214. Accordingly, mat 250 can be fed through slotted opening 310 to enter or exit the cleaning system.

Mat sleeve 302 defines a mat roll receiving space 312 that is configured to receive mat 250 in rolled configuration 294 and feed the mat to slotted opening 310 through a sleeve opening 314 between mat sleeve 302 and an internal wall 314 when mat roll chamber 300 is coupled to inlet 206 (mat roll chamber 300a). Additionally or alternatively, mat roll receiving space 312 is configured to receive mat 250 and wind the mat into rolled configuration 294 as the mat is fed through slotted opening 310 and sleeve opening 314 when mat roll chamber 300 is coupled to outlet 214 (mat roll chamber 300b).

In alternate examples, the mat unrolling subsystem and/or the mat rolling subsystem can have a different configuration. In one specific alternate example, the mat unrolling subsystem can comprise a rod configured to receive the mat in a rolled configuration. In other words, the rod is configured to be inserted through a center of the mat in the rolled configuration. The rod can be configured to rotate to feed the mat into the inlet and the cleaning system. In another specific alternate example, the mat rolling subsystem can include a rod that includes a mechanism for releasably mating with a lateral edge of the mat (e.g., via magnetic partners in the rod and an end of the mat, a clamp on the rod, etc.). The rod of the mat rolling subsystem can also be configured to rotate in order to wind the mat around the rod into the rolled configuration. The mechanism for mating the mat to the rod should be releasable and/or a weak enough connection that the user can easily remove the mat from the rod after the mat is in the rolled configuration.

Returning to FIG. 14, also in contrast to cleaning system 100, cleaning system 200 includes a graphical user interface (GUI) 296. GUI 296 is depicted in FIG. 14 and is disposed on a front of housing 280. It will be appreciated that the GUI can alternatively be disposed on any desired location of the cleaning system or be a remote GUI that is not directly attached to the cleaning system. It will be appreciated that cleaning system 100 can include a GUI and/or cleaning system 200 can exclude the GUI.

GUI 296 can receive user input and/or display information about the user and/or the cleaning system. For example, the GUI can receive a command to initiate a cleaning cycle and/or receive a code or other payment information. In other examples, the GUI can display a user identification, a status of the exercise mat cleaning process, a fluid level in the cleaning solution reservoir, a time remaining for the exercise mat cleaning process, and/or conservation information related to the number of exercise mat cleanings performed and a number of waste products saved (e.g., a number of paper towels saved).

GUI 296 can be coupled to and/or in data communication with a computer system associated with the cleaning system (not specifically shown). In some examples the GUI includes a WiFi transmitter configured to be in wireless communication with a computer system and/or a network. The network can be configured to collect, store, and/or send user identification, usage, and/or operational status information.

The GUI and/or the computer system can be further coupled to and/or in data communication with mat recognition subsystem 204. In this example, the cleaning system can track a number of cleanings associated with a specific user (i.e., a specific user is identified with a specific tag in a mat). The computer system can then automatically charge the user for each cleaning, keep a total of number cleanings associated with the user for later payment, or subtract a number of cleanings from cleaning credits associated with the user.

Further, the computer system can be linked to a network for identifying a location of the user (e.g., a specific gym or studio) and/or notifying a social network of the location of the user. The information provided will give usage, day/time/location, which can be linked to the schedule of one or more specific studios and/or gyms so that information such as the specific class taken, instructor present, duration of class, and/or difficulty of class can all be captured. This information can be shared on online through social platforms with a community of people that the user can choose to share that information with. Further, it can be used to connect people who attend the same classes, live in the same area, and/or share interest in similar types of classes. Furthermore, tracking of classes taken, total hours studied, benchmark awards and goals, can all be set from this data logging. Additionally or alternatively, notifications can also be sent to a group of friends that either attended the same class or have been attending the same class, and then missed the class. In one specific example, a message can be sent reading “Julie, Jen, and Jessica just finished Vinyasa Flow II taught by Karen today. We missed having you there. We hope to see you next Tuesday for our same class.” Furthermore, suggested classes can be made so that the users can gain exposure to other types of yoga and/or exercise classes that might appeal to them.

Finally, it will be appreciated that although housings 180 and 280 are depicted as skeletal structures (i.e., lacking outer walls) for housing the components of cleaning systems 100 and 200, respectively, the housings can additionally include outer walls. In these examples, the components of the cleaning systems can be enclosed by the outer walls, giving the cleaning system an aesthetically pleasing outer appearance. Further, the outer walls of the housing can include instructions for operation of the cleaning system, logos, and/or other decorative images that are viewable by a user. Furthermore, it will be appreciated that although the pathway of movement of the mat through the cleaning system is linear in both of the depicted examples (i.e., cleaning systems 100 and 200), in alternate examples, the mat can have a serpentine pathway. One advantage of a serpentine pathway for the mat includes the use of perpendicular gravitational forces to draw debris and cleaning solution off. Also, through a bend of a mat conveyance pathway the outer plane grooves, pores, and textures of the mat are exposed for better cleaning of the mat topography than when the mat is moved through the cleaning system in a linear fashion.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. An exercise mat cleaning system for cleaning and disinfection of an exercise mat having a first surface and a second surface, the system comprising:
a housing having at least,
a debris removal subsystem for removing larger debris from at least the first surface,
a disinfection subsystem for removing smaller debris and contaminants from at least the first surface, the disinfection subsystem being downstream of the debris removal subsystem,
an inlet for feeding the exercise mat into the housing, the inlet being upstream of the debris removal subsystem, and
an outlet for feeding the exercise mat out of the housing, the outlet being downstream of the disinfection subsystem.

2. The exercise mat cleaning system of claim 1, further comprising an approved mat recognition subsystem upstream of the inlet.

3. The exercise mat cleaning system of claim 2, wherein the approved mat detection subsystem comprises a RFID recognition system configured to recognize an acceptable RFID tag and operate the mat cleaning system in response to detection of the acceptable RFID tag that is integral to the exercise mat.

4. The exercise mat cleaning system of claim 2, wherein the approved mat detection subsystem comprises an optical recognition system configured to recognize an acceptable optical tag and operate the mat cleaning system in response to detection of the acceptable optical tag that is integral to the exercise mat.

5. The exercise mat cleaning system of claim 2, wherein the approved mat detection subsystem comprises a magnetic recognition system configured to recognize a magnetic tag and operate the mat cleaning system in response to detection of the acceptable magnetic tag that is integral to the exercise mat.

6. The exercise mat cleaning system of claim 1, further comprising a drying subsystem downstream of the cleaning and disinfection subsystem and upstream of the outlet.

7. The exercise mat cleaning system of claim 6, wherein the drying subsystem comprises one or more of brushes, wiper blades, compressive rollers, forced air, and UV light configured to dry at least the first surface.

8. The exercise mat cleaning system of claim 1, further comprising a mat roll retaining and feeding subsystem upstream of the inlet, the mat roll retaining and feeding subsystem configured to receive the exercise mat in a rolled configuration and feed the exercise mat to the inlet.

9. The exercise mat cleaning system of claim 1, further comprising a mat rolling subsystem downstream of the outlet, the mat rolling subsystem configured to roll the exercise mat into a rolled configuration as the exercise mat is fed out of the outlet.

10. The exercise mat cleaning system of claim 1, wherein the inlet has a first pair of rollers that are cooperatively rotatable and operable to receive the exercise mat between opposing rollers of the first pair of rollers and feed the exercise mat into the housing.

11. The exercise mat cleaning system of claim 10, wherein disinfection subsystem has a second pair of rollers that are cooperatively rotatable and operable to receive the exercise mat between opposing rollers of the second pair of rollers, the second pair of rollers having a textured surface configured to agitate at least the first surface.

12. The exercise mat cleaning system of claim 11, wherein the first set of rollers are operable at a first speed and the second pair of rollers are operable at a second speed, the second speed being faster than the first speed.

13. The exercise mat cleaning system of claim 1, wherein the disinfection subsystem has a cleaning solution reservoir for delivery of fresh and unused cleaning solution onto at least the first surface.

14. The exercise mat cleaning system of claim 13, wherein the cleaning solution reservoir is operatively connected to one or more spray assemblies, the one or more spray assemblies configured to spray the fresh and unused cleaning solution on at least the first surface.

15. The exercise mat cleaning system of claim 13, wherein the cleaning solution reservoir is operatively connected to the second set of rollers, second set of rollers being configured to dispense the fresh and unused cleaning solution onto at least the first surface as the second set of rollers are rotated.

16. The exercise mat cleaning system of claim 1, further comprising a graphical user interface operatively connected to sensors within the housing and configured to display user information, the user information including one or more of a user identification, a status of the exercise mat cleaning process, a fluid level in the cleaning solution reservoir, a time remaining for the exercise mat cleaning process, conservation information related to the number of exercise mat cleanings performed, and a number of waste products saved.

17. The exercise mat cleaning system of claim of claim 1, further comprising a mat guide mechanism for aligning opposing longitudinal edges of the exercise mat through one or more of the inlet, the debris removal subsystem, the disinfection subsystem, and the outlet.

18. The exercise mat cleaning system of claim 1, wherein the system is configured to simultaneously clean the first surface and the second surface, the second surface being an opposing surface relative to the first surface.

19. The exercise mat cleaning system of claim 1, further comprising a continuous track mechanism for moving the exercise mat through the inlet, the debris removal subsystem, the disinfection subsystem, and the outlet.

20. The exercise mat cleaning system of claim 1, further comprising a WiFi transmitter configured to be in wireless data communication with a network, the network configured to collect, store, and send user identification, usage, and operational status information.

21. The exercise mat cleaning system of claim 1, wherein components of the inlet, the debris removal subsystem, the disinfection subsystem, and the outlet are configured to be removable and replaceable.

22. An exercise mat cleaning system for cleaning and disinfection of an exercise mat having a first surface and a second surface, the system comprising:
a housing having at least,
a debris removal subsystem for removing larger debris from at least the first surface, and
a disinfection subsystem for removing smaller debris and contaminants from at least the first surface, the cleaning and disinfection subsystem being downstream of the debris removal subsystem,
an inlet for feeding the exercise mat into the housing, the inlet being upstream of the debris removal subsystem,
an approved mat recognition subsystem upstream of the inlet configured to recognize an acceptable tag in the exercise mat and operate the exercise mat cleaning system in response to detection of the acceptable tag, and
an outlet for feeding the exercise mat out of the housing, the outlet being downstream of the disinfection subsystem.

23. An exercise mat cleaning system for cleaning and disinfection of an exercise mat having a first surface and a second surface, the system comprising:
a housing having at least,
a debris removal subsystem for removing larger debris from at least the first surface,
a disinfection subsystem for removing smaller debris and contaminants from at least the first surface, the cleaning and disinfection subsystem being downstream of the debris removal subsystem,
an inlet for feeding the exercise mat into the housing, the inlet being upstream of the debris removal subsystem,
an outlet for feeding the exercise mat out of the housing, the outlet being downstream of the disinfection subsystem, and
a mat guide mechanism for aligning opposing longitudinal edges of the exercise mat through one or more of the inlet, the debris removal subsystem, the disinfection subsystem, and the outlet.
